(19) United States
(12) Patent Application Publication
(10) Pub. No.: US 2024/0300453 A1
(43) Pub. Date: Sep. 12, 2024

(54) SAFETY SYSTEM FOR A ROOFTOP OF A VEHICLE

(71) Applicant: ICE CAPTURE ENTERPRISE INC. (I.C.E. INC.), Waynesboro, PA (US)

(72) Inventor: Norman E. DUNBAR, Waynesboro, PA (US)

(21) Appl. No.: 18/599,421

(22) Filed: Mar. 8, 2024

Related U.S. Application Data
(60) Provisional application No. 63/489,067, filed on Mar. 8, 2023.

(51) Int. Cl. B60S 1/66

(52) U.S. Cl. CPC B60S 1/66

(57) ABSTRACT

A safety system for preventing ice from falling out from a rooftop of a vehicle is provided. The system includes a grating structure and locking elements. The grating structure includes a plurality of members configured to form a substantially enclosed space between the grating structure and the rooftop so as to hold in-place ice formed on the rooftop and prevent the ice from falling from the rooftop. The grating structure further includes a plurality of openings oriented to receive snow and water therethrough.

This application claims priority to U.S. Provisional application No. 63/489,067 entitled “A Safety System for a Roof of a Vehicle” filed Mar. 8, 2023, in which the entire contents of the foregoing application is incorporated herein by reference.

### FIELD OF DISCLOSURE

The present disclosure relates to a system for preventing ice from falling out from a rooftop of a vehicle.

### BACKGROUND

In a cold climate, snow and ice may accumulate on vehicles, including trailer rooftops of tractor-trailers or semi-trucks. Trailer rooftops of tractor-trailers generally have large and flat surfaces, and accumulations of snow and ice may form a thick layer of ice on the top of the trailer rooftops. Ice falling off trailer rooftops poses a significant risk to other drivers on the road. Also, it can cause damage to other vehicles or property on the road and/or injury to people, resulting in costly repairs or replacements and medical bills.

There are many incidents and/or accidents caused by ice falling off vehicle rooftops. For instance, thick sheets of ice can slide off the truck and hit another vehicle that is traveling behind the truck, causing massive property damage to the vehicle and severe injuries to the passengers inside. More specifically, a large piece of ice can fall off a tractor-trailer, crashes into the windshield of a passenger vehicle, and seriously injuring the passenger including death. Although it is encouraged for drivers to clear the snow and ice off their vehicles, drivers are not always aware when ice falling off their truck causes an accident, not to mention, it can be dangerous for truckers to climb on top of icy trailers rooftops and clear snow and ice.

Prior art devices include large scraper structures at truck stops in which trucks drive through the scraper structures to clear snow off their tops. Other prior art devices blow air to remove the snow from vehicle rooftops. However, none of the existing prior art prevents and/or reduces ice from falling out from a rooftop of a vehicle.

Therefore, there remains a need for a safety system to prevent ice from falling out from a rooftop of a vehicle.

### SUMMARY

In an exemplary embodiment, a system for preventing ice from falling out from a rooftop of a vehicle, including a grating structure and locking elements, the grating structure includes a plurality of members configured to form a substantially enclosed space between the grating structure and the rooftop so as to hold in-place ice formed on the rooftop and prevent the ice from falling out from the rooftop. The grating structure comprises a plurality of openings oriented to receive snow and water therethrough.

In another exemplary embodiment, a safety system for preventing ice from falling out from a rooftop of a vehicle, including a plurality of grating structures and locking elements, each of the plurality of grating structures includes a plurality of members configured to form a substantially enclosed space between each of the plurality of grating structures and the rooftop so as to hold in-place ice formed on the rooftop and prevent the ice from falling out from the rooftop. Each of the plurality of grating structures comprises a plurality of openings oriented to receive snow and water therethrough.

Other features and advantages of the present invention will be apparent from the following more detailed description of exemplary embodiments, taken in conjunction with the accompanying drawings, which illustrate, by way of example, the principles of the invention.

### BRIEF DESCRIPTION OF THE DRAWINGS

FIG. 1A is a perspective view of an exemplary system for preventing ice from falling out from a rooftop of a vehicle.

FIG. 1B is a partial perspective view of an exemplary system of FIG. 1A.

FIG. 1C is a perspective top view of an exemplary system of FIG. 1A for preventing ice from falling out from a rooftop of a vehicle.

FIG. 2A is an upper rear perspective view of an exemplary system for preventing ice from falling out from a rooftop of a vehicle.

FIG. 2B is an upper front perspective view of the exemplary system of FIG. 2A.

FIG. 2C is an upper rear perspective view of an alternate embodiment of a system for preventing ice from falling out from a rooftop of a vehicle.

FIGS. 3A-3C are perspective views of an exemplary grating structure according to an example embodiment.

FIG. 4A is a front side view of the grating structure of FIG. 3A.

FIG. 4B is a rear side view of the grating structure of FIG. 3A.

FIG. 4C is a left or right side view of the grating structure of FIG. 3A.

FIG. 5 is a rear view of the of the grating structure when viewed behind a vehicle according to an example embodiment.

FIGS. 6A-6C are perspective views of alternative grating structures according to example embodiments.

FIGS. 7A and 7B are rear views of the of the alternative grating structure of FIGS. 6A and 6B when viewed behind a vehicle according to an example embodiment.

FIGS. 8A and 8B are rear views of the of the alternative grating structure of FIG. 6C when viewed behind a vehicle according to an example embodiment.

FIG. 9A is a front side view of the grating structure of FIG. 6A.

FIG. 9B is a rear side view of the grating structure of FIG. 6A.

FIG. 9C is a left side view of the grating structure of FIG. 6A.

FIG. 9D is a right side view of the grating structure of FIG. 6A.

FIGS. 10A and 10B are perspective views of an alternative grating structure according to an example embodiment.

FIG. 11A is a cross-section view of the grating structure of the system according to an example embodiment.

FIG. 11B is a perspective view of locking elements according to an example embodiment.

FIG. 12A is an upper side perspective view of drainage members according to an example embodiment.

FIG. 12B is an upper perspective view of locking elements according to an example embodiment.

FIG. 12C is an upper perspective view of a portion of a side member of an example embodiment of a grating structure according to an example embodiment.

FIG. 12D is a section view of joint elements according to an example embodiment.

FIG. 12E is a side view of locking elements according to an example embodiment.

FIG. 13A is an upper perspective view of an example embodiment of top members, side members, and joint elements of a grating structure according to an example embodiment.

FIG. 13B is an upper perspective view of an alternate example embodiment of top members, side members, and joint elements of a grating structure according to an example embodiment.

FIG. 13C is an upper perspective view of an alternate example embodiment of joint elements of a grating structure according to an example embodiment.

Wherever possible, the same reference numbers will be used throughout the drawings to represent the same parts.

### DETAILED DESCRIPTION

Provided herein is an exemplary safety system for preventing ice from falling from a rooftop of a vehicle, i.e., preventing ice from blowing away from the vehicle's rooftop while in motion. Example embodiments of the present disclosure provide for a system that holds in-place ice formed on a rooftop and prevents the ice from falling from the rooftop. Example embodiments of the present disclosure further provide for a system that removes or dissipates ice (i.c., melts) formed on a rooftop of a vehicle.

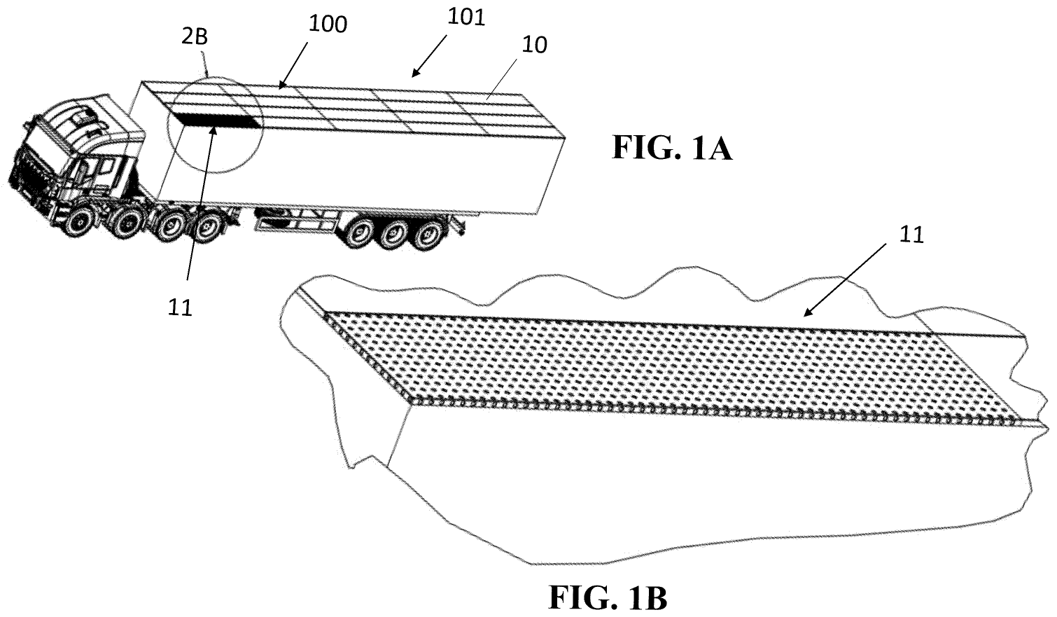

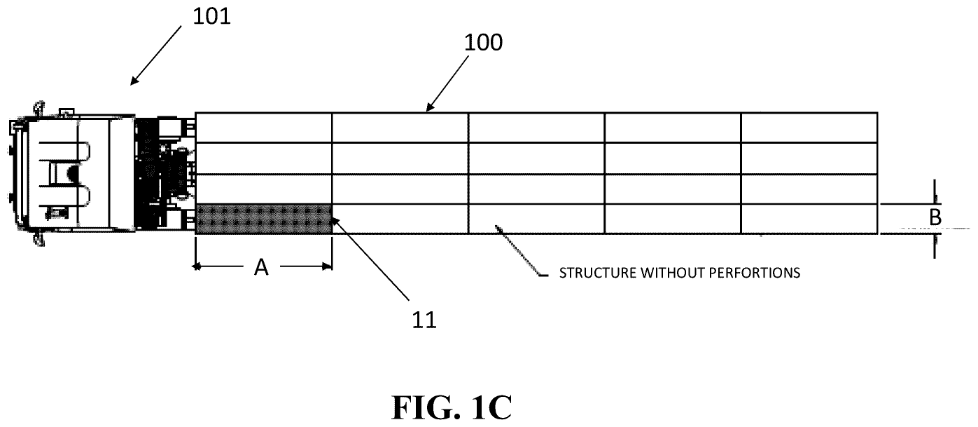

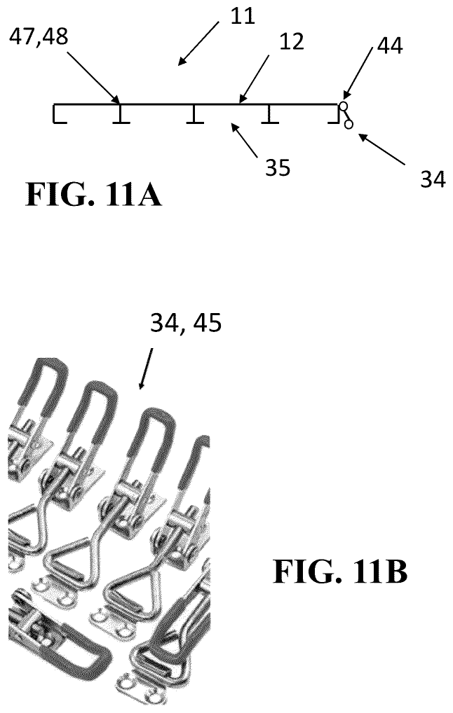

Referring to FIGS. 1A through 1C, in one example embodiment, a safety system (100) for preventing ice from falling from a rooftop (10) of a vehicle (101) is shown. The safety system (100) may include a grating structure (11) configured to be mounted on a rooftop (10) of the vehicle (101) and secured to the rooftop (10) via locking elements (34) (FIGS. 11A and 11B), which will be described in detail later.

As shown in FIG. 1A, the grating structure (11) is configured to be form as multiple structures formed on the rooftop (10). In one implementation, the grating structure (11) can be 115 inches in length (A) and 25.25 inches in width (B), for example. It should be appreciated that the grating structure (11) can be of any dimension (length and width) as long the grating structure (11) conforms to the shape of the rooftop (10) of the vehicle (101). In some implementations, the grating structure (11) is configured to be formed as a single structure formed on the rooftop (10).

In some implementations, the grating structure (11) can be made from a light-weight metal material, such as, but not limited to, aluminum, copper, brass, stainless steel, galvanized steel, and the like. It should be appreciated that other materials can be employed dependent on environmental factors to maintain the structural integrity of the grating structure (11)

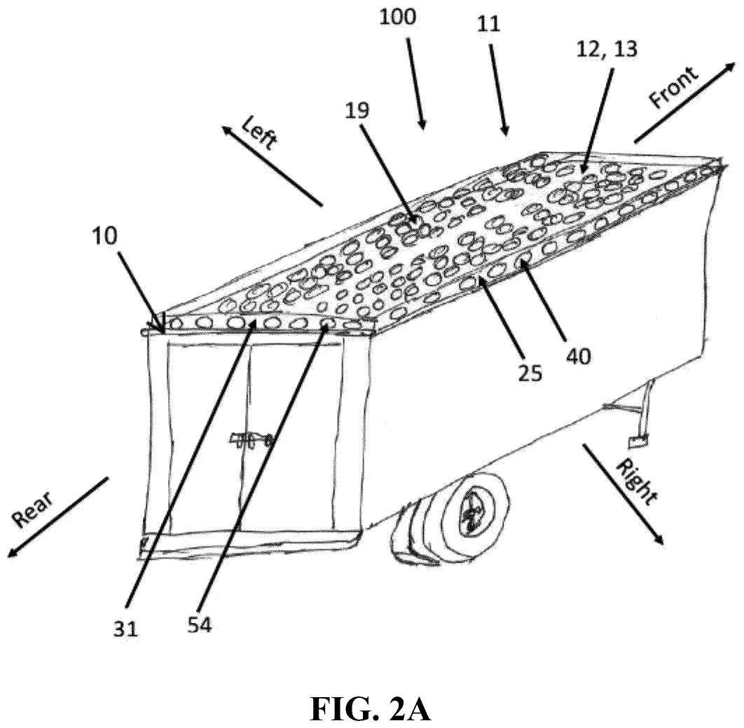

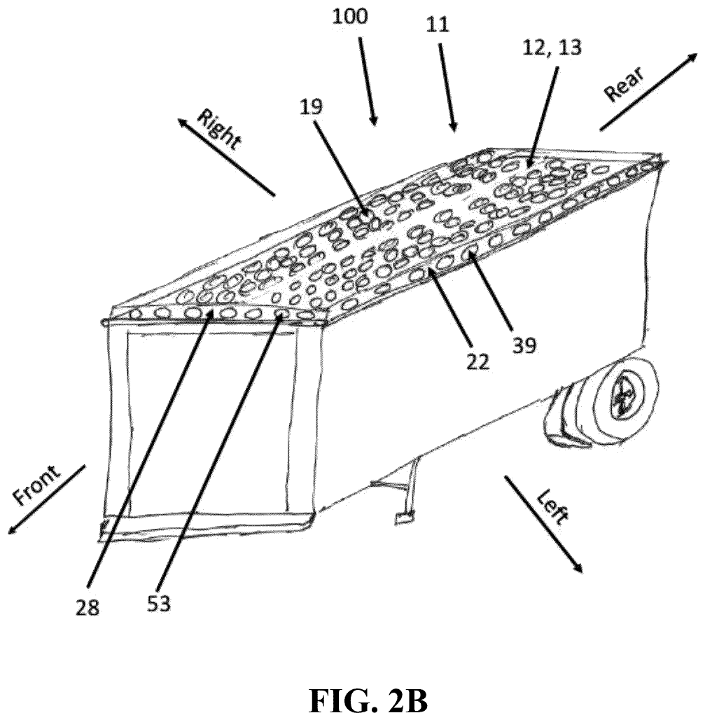

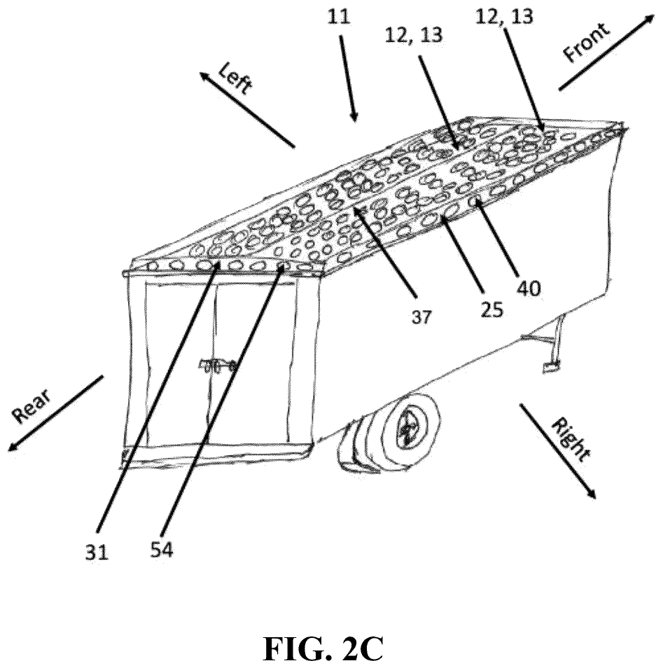

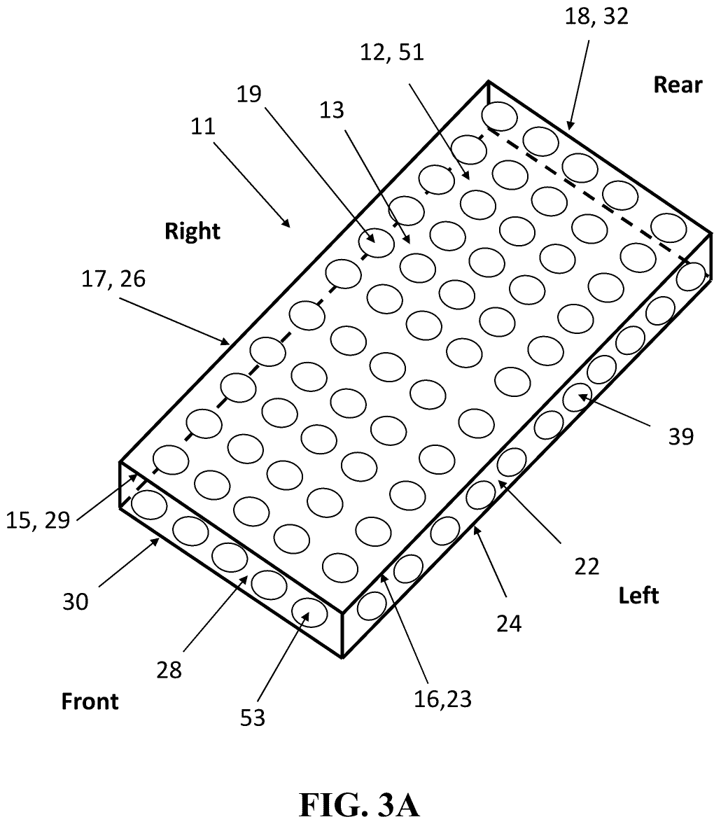

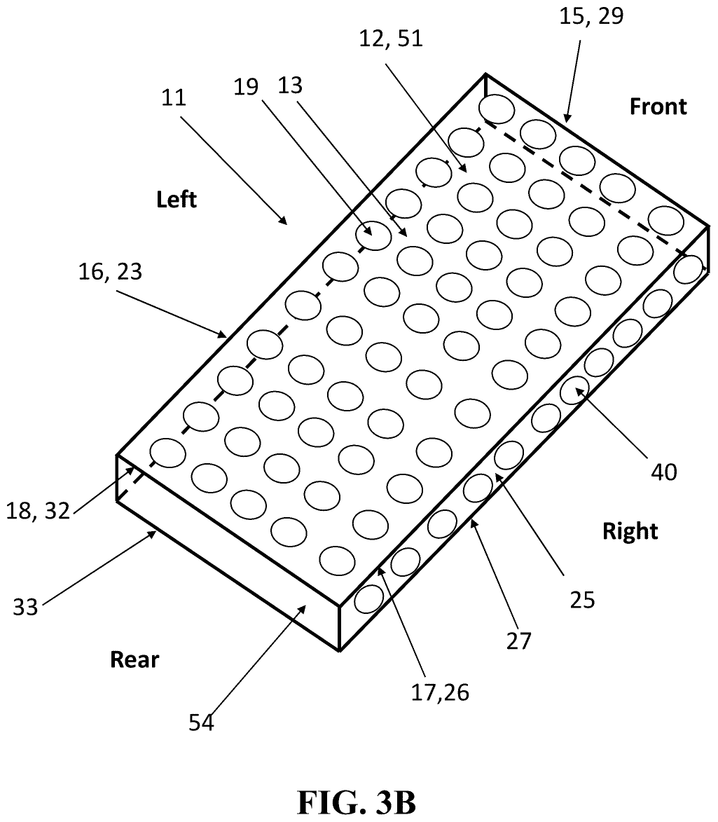

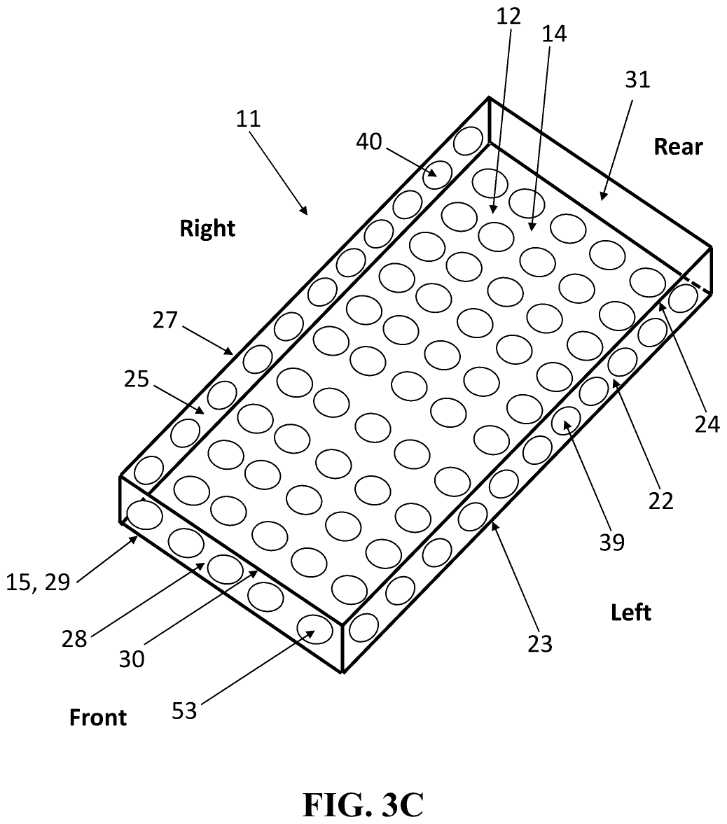

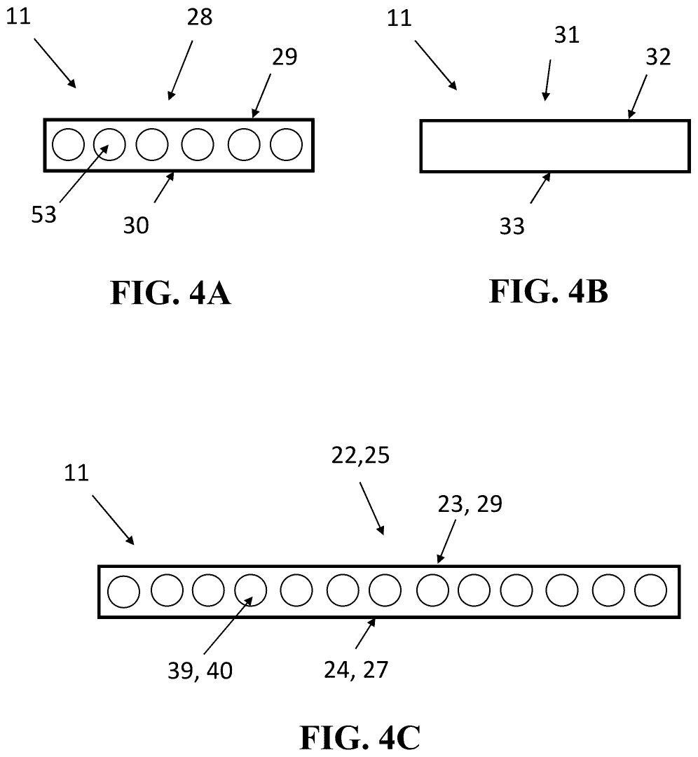

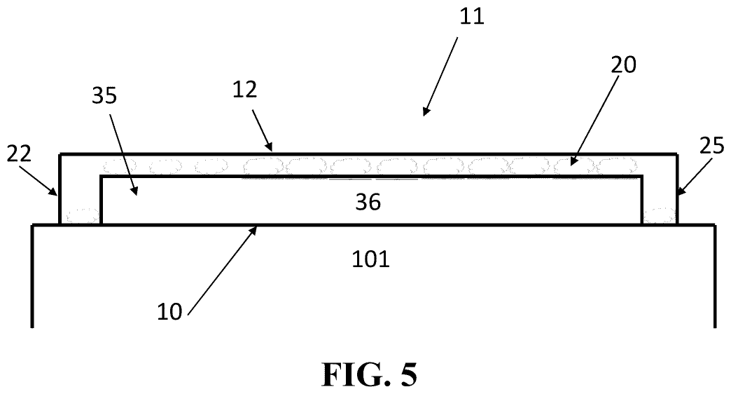

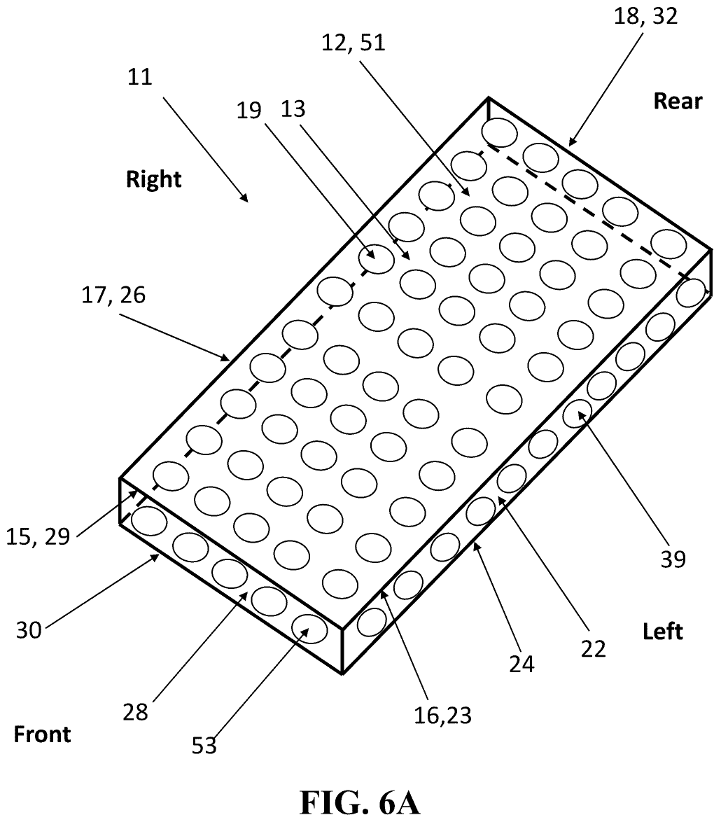

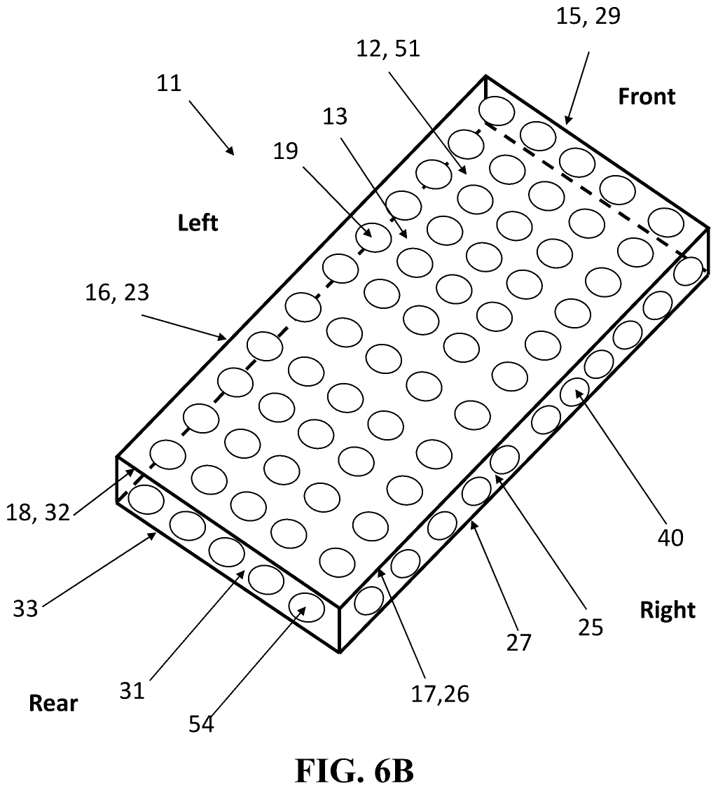

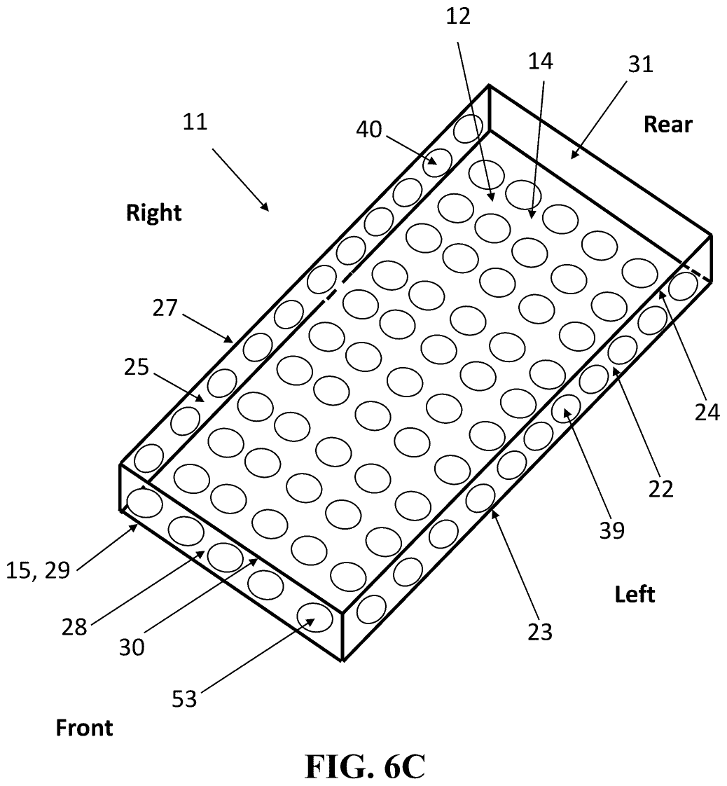

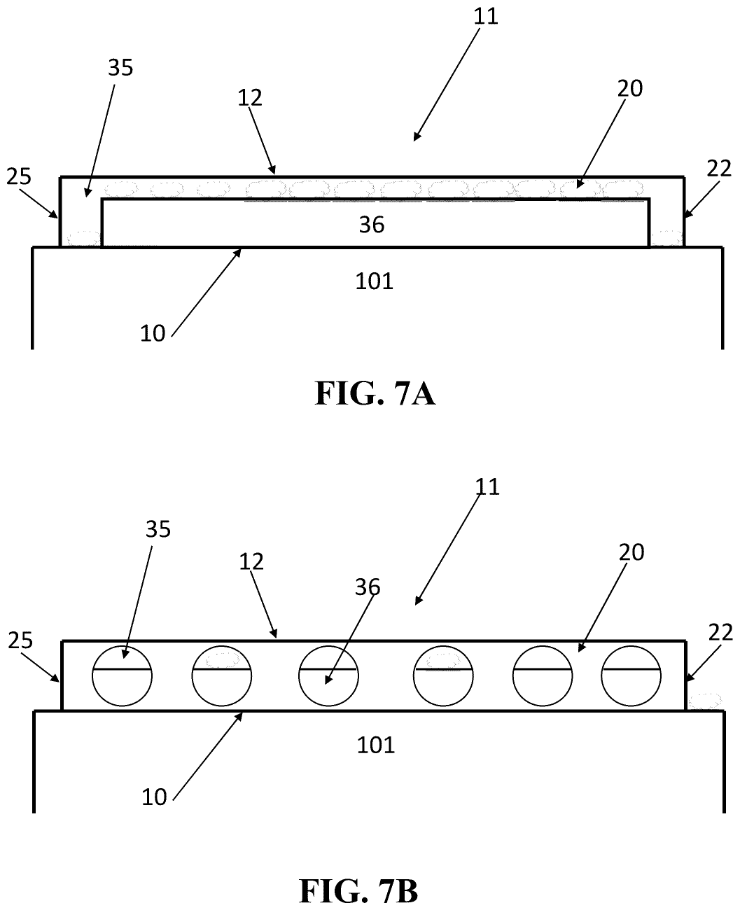

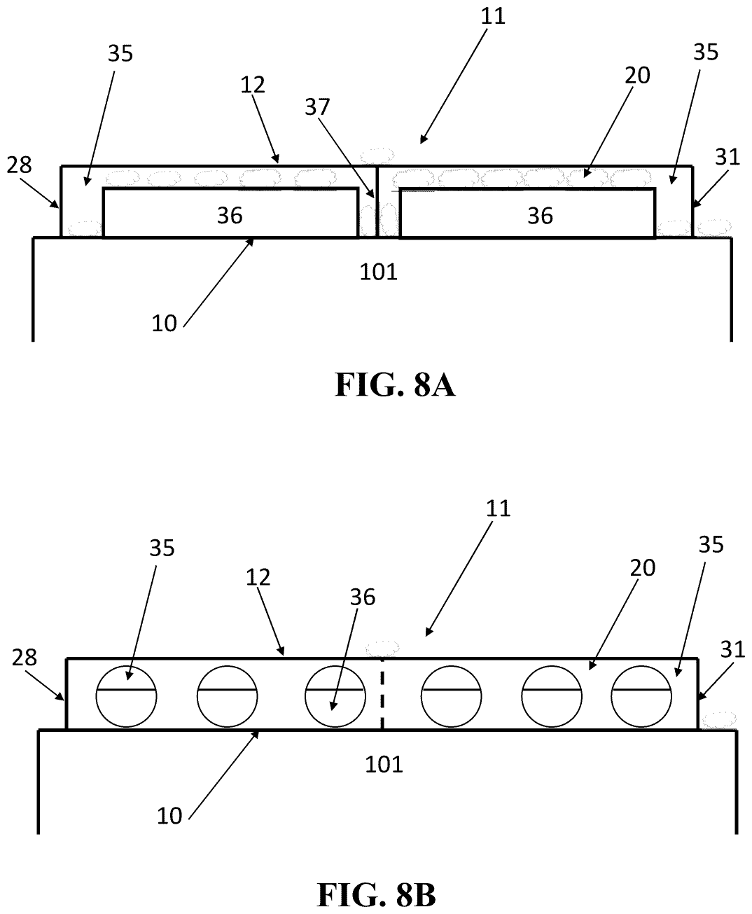

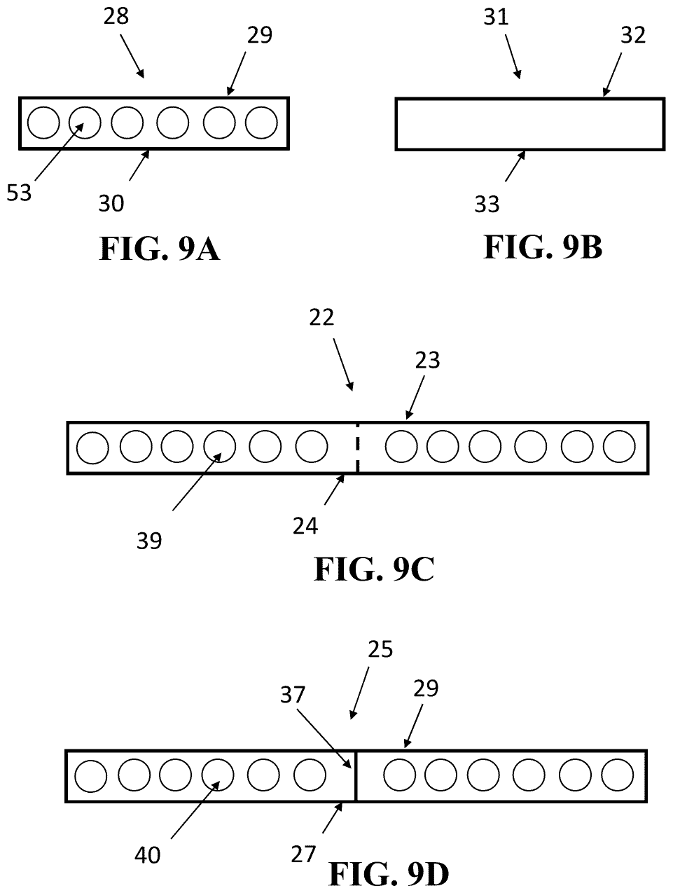

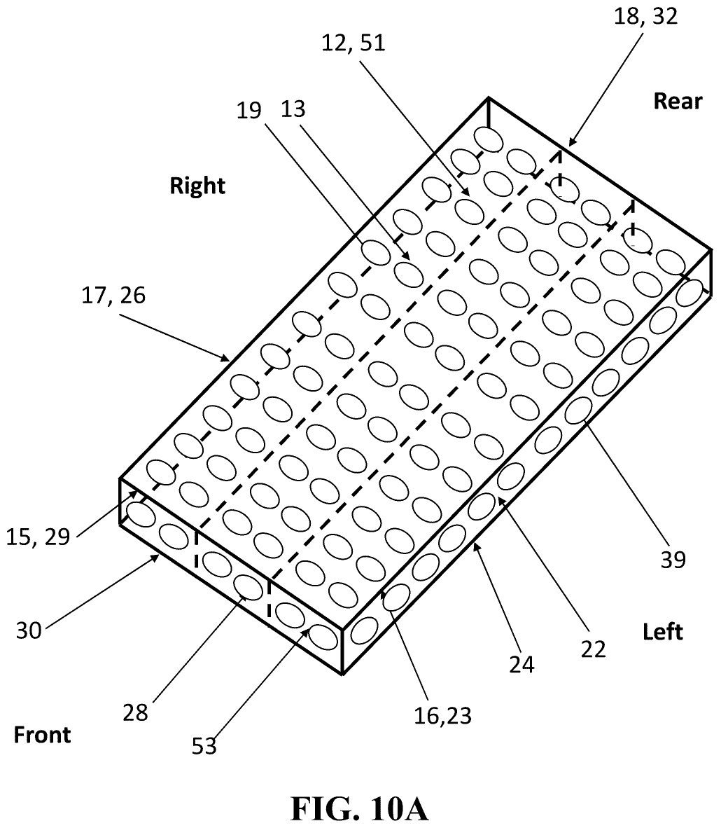

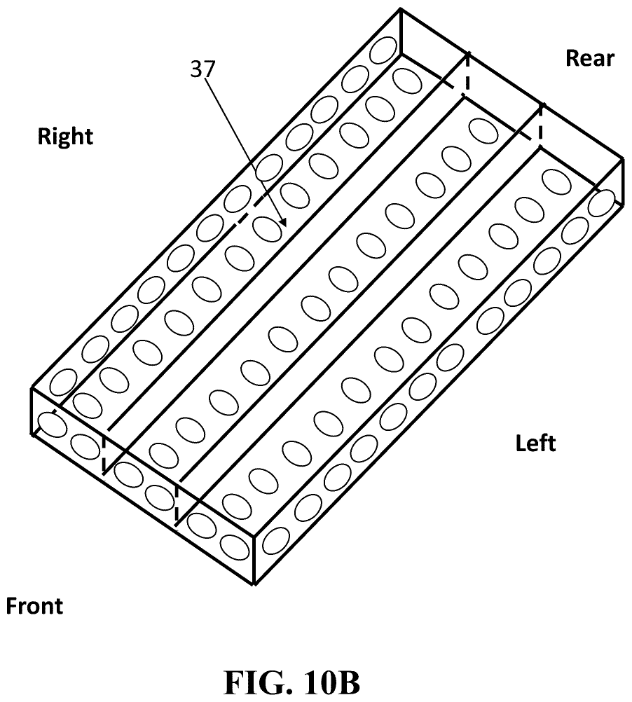

Referring to FIGS. 2A and 2B, the grating structure (11) may include a top member (12), a left-side member (22), a right-side member (25), and a rear member (31). In one implementation, the top member (12), the left-side member (22), and the right-side member (25) of the grating structure (11) are configured to form a substantially enclosed space (35) (as shown in FIG. 5) between the grating structure (11) and the rooftop (10) so as to hold in-place ice (36) formed on the rooftop (10) and prevent the ice (36) from falling out from the rooftop (10) while the vehicle (101) is in motion. The enclosed space (35) should of sufficient volume or area to hold the formed ice (36) within the enclosed space (35) and prevent the ice (36) from falling off the rooftop (10). In some implementations, the enclosed space (35) can be enlarged by raising the height of the left-side member (22) and the right-side member (25) of the grating structure (11).

The top member (12) may include a plurality of openings (19) configured to receive snow and water therethrough. The openings (19) may be oriented in a uniform configuration or may be oriented in a staggered configuration in the top member (12). In one implementation, the openings (19) may be approximately one to three inches wide, for example. In some implementations, the openings (19) can be substantially circular in shape. Other shapes, such as, oval, square, rectangular, polygon, and/or triangular can be employed. In some implementations, the openings (19) may be 1 inch apart from each other. In some implementations, the openings (19) can be of different sizes. For instance, one opening (19) can be one inch and another opening (19) can be two inches. It should be appreciated other dimensions and/or sizes may be employed.

In some implementations, the top member (12) of the grating structure (11) may be planar shape and may have a top surface (13) and a bottom surface (14), such that the top surface (13) faces away from the rooftop (10) and the bottom surface (14) faces toward the rooftop (10). The top member (12) may have a front end (15), a left end (16), a right end (17), and a rear end (18).

The left-side member (22) may extend from the left end (16) of the top member (12) downwardly to the rooftop (10). The left-side member (22) has a top end (23) and a bottom end (24). In one implementation, the left-side member (22) is configured to be attached to the top member (12) at and along the top end (23) and to attach to the rooftop (10) at and along the bottom end (24).

The right-side member (25) may extend from the right end (17) of the top member (12) downwardly to the rooftop (10). The right-side member (25) has a top end (26) and a bottom end (27). In one implementation, the right-side member (25) is configured to be attached to the top member (12) at and along the top end (26) and to attach to the rooftop (10) at and along the bottom end (27).

The rear member (31) may extend from the rear end (18) of the top member (12) downwardly to the rooftop (10). The rear member (31) has a top end (32) and a bottom end (33). In one implementation, the rear member is configured to be attached to the top member (12) at and along the top end (32) and to attach to the rooftop (10) at and along the bottom end (33).

Referring to FIG. 2B, in one example embodiment, the left-side member (22) includes a plurality of openings (39). In some implementations, the openings (39) may be oriented in a uniform configuration (i.e., consistently) that extend across substantially the entire surface of the left-side member (22). In other implementations, the openings (39) may extend across only a portion of the surface of the left-side member (22).

In one example embodiment, the left-side member (22) may have a height dimension in a range from about one inch to about three inches. In a preferred embodiment, the left-side member (22) may have a height dimension of about two inches. It should be appreciated that the left-side member (22) may have a height dimension that is less than or greater than the aforementioned heights.

Referring to FIG. 2A, in one example embodiment, the right-side member (25) may comprise a plurality of openings (40). In some implementations, the openings (40) may be oriented in a uniform configuration (i.e., consistently) that extend across substantially the entire surface of the right-side member (25). In other implementations, the openings (40) may extend across only a portion of the surface of the right-side member (25).

In one example embodiment, the right-side member (25) may have a height dimension in a range from about one inch to about three inches. In a preferred embodiment, the left-side member (25) may have a height dimension of about two inches. It should be appreciated that the right-side member (25) may have a height dimension that is less than or greater than the aforementioned heights.

Referring to FIG. 2A, in one example embodiment, the rear member (31) may comprise a plurality of openings (54). In some implementations, the openings (54) may be oriented in a uniform configuration (i.e., consistently) that extend across substantially the entire surface of the rear member (31). In other implementations, the openings (54) may extend across only a portion of the surface of the rear member (31).

In one example embodiment, the rear member (31) has a height dimension in a range from about one inch to about three inches. In a preferred embodiment, the rear member (31) may have a height dimension of about two inches. It should be appreciated that the rear member (31) may have a height dimension that is less than or greater than the aforementioned heights.

Referring to FIG. 2B, in one example embodiment, the grating structure (11) may include a front member (28). The top member (12), the left-side member (22), the right-side member (25), and the front member of the grating structure (11) are configured to form a substantially enclosed space (35) between the grating structure (11) and the rooftop (10) so as to hold in-place ice (36) formed on the rooftop (10) and prevent the ice (36) from falling out from the rooftop (10).

The front member (28) may extend from the front end (15) of the top member (12) downwardly to the rooftop (10). The front member (28) may have a top end (29) and a bottom end (30). The front member (28) is configured to be attached to the top member (12) at and along the top end (29) and to attach to the rooftop (10) at and along the bottom end (30).

Referring to FIG. 2B, in one example embodiment, the front member (28) may include a plurality of openings (53). In some implementations, the openings (53) may be oriented in a uniform configuration (or consistently) that extend across substantially the entire surface of the rear member (31). In other implementations, the openings (53) may extend across only a portion of the surface of the front member (28).

In one example embodiment, the front member (28) has a height dimension in a range from about one inch to about three inches. In a preferred embodiment, the front member (28) may have a height dimension of about two inches. It should be appreciated that the rear member (31) may have a height dimension that is less than or greater than the aforementioned heights.

Referring to FIG. 2C, in an alternative embodiment, the grating structure (11) includes a center member (37) extending from the front member (28) to the rear member (31). To describe differently, the center member (37) splits the grating structure (11) into two main portions attached together at their respective side ends. The center member (37) also extends from the bottom surface (14) of the top member (12) downwardly towards the rooftop (10). In another example embodiment, the center member (37) is configured to form a plurality of substantially enclosed spaces (35) between the grating structure (11) and the rooftop (10). The center member (37) provides structural strength to the grating structure (11) when heavy snow is accumulated thereon, reducing buckling and/or bending in the middle portion of the grating structure (11). In some implementations, the center member (37) can include openings extending along the entire portion or partial portion of the center member (37).

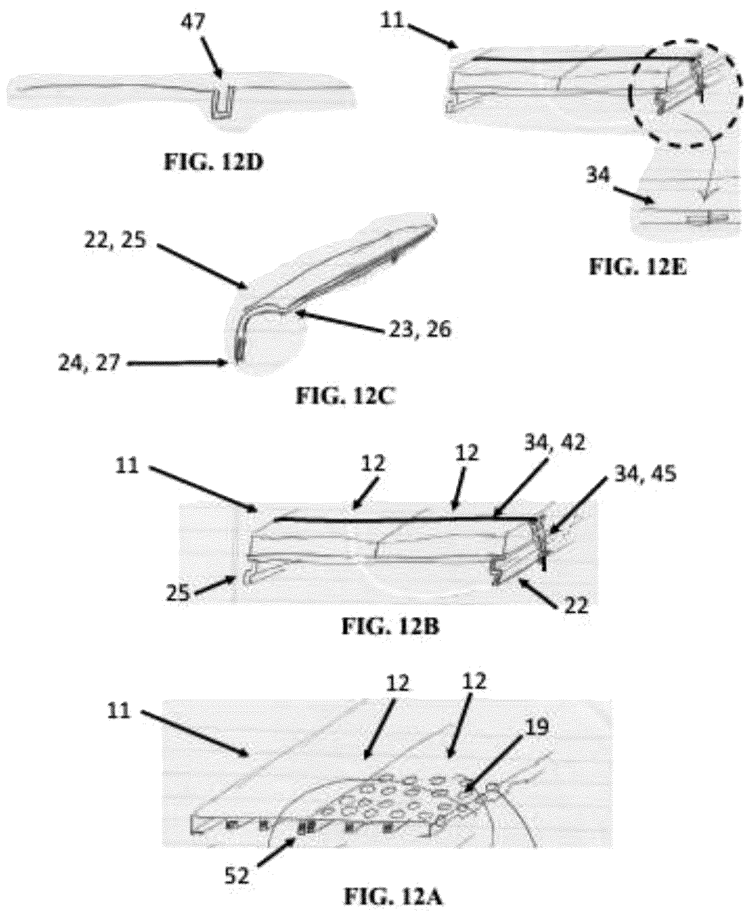

Referring to FIG. 12A, in one example embodiment, the top member (12) includes at least one drainage member (52) formed at the bottom surface (14) of the top member (12) configured to drain away water flowed through the plurality of openings (19). In some implementations, the drainage member (52) may extend across the entire surface of the bottom surface (14) or may extend at only a portion of the surface of the bottom surface (14). In some implementations, the drainage member (52) may be uniformly spaced away from each other. In some implementations, the drainage member (52) may be formed at the left-side member 22 and/or right-side member 25 of the grating structure (11).

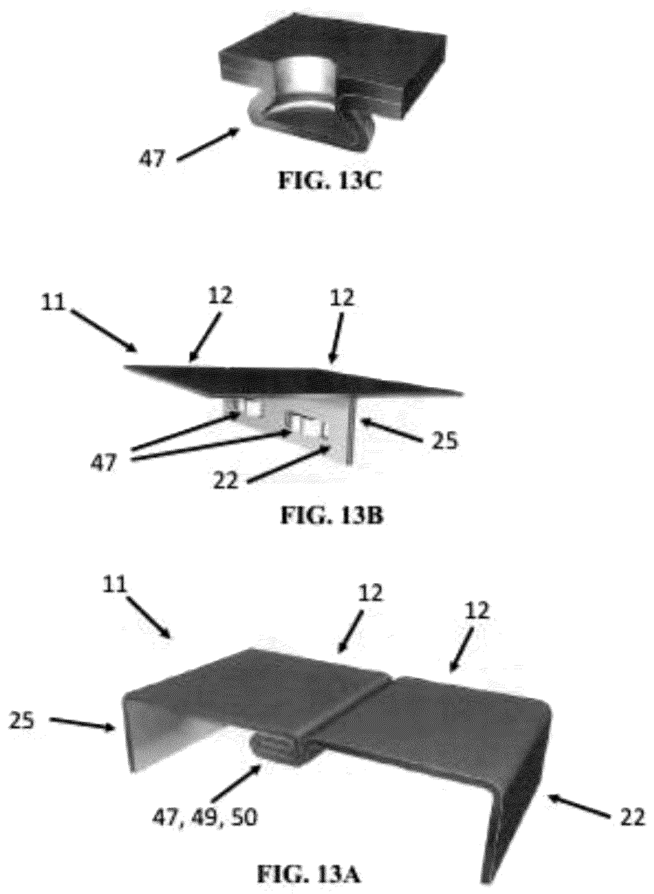

Referring to FIGS. 13A-13C, in one example embodiment, top member (12), the left-side member (22), the right-side member (25), the rear member (31), and the front member (28) are cach configured to be connectible with one another. In one implementation, the top member (12) is configured to have a connecting element (48) such that each top member (12) is connectible with one another. In one implementation, the connecting element (48) is a tongue and groove joint. In one implementation, the connecting clement (48) is a snap-fit joint, including, but not limited to, cantilever snap joints, torsion snap joints, annular snap joints. It should be appreciated that other types of connecting element (48) can be employed. It should further be appreciated that the connecting element (48) as described herein should be connection types that can be quickly assembled and disassembled from each other. It should further be appreciated that the grating structure (11) can be formed as a single unitary member and not individually connected.

Referring to FIG. 12B, in one example embodiment, locking elements (34) are shown. In one implementation, the locking clements (34) can be straps (42) and ratchets (43). The straps (42) and ratchets (43) are configured to secure the grating structure (11) onto the rooftop (10), whereby the ratchets (43) are affixed to the vehicle (101). In another example embodiment, the locking elements (34) may comprise straps (42) and snap-fit joints. The straps (42) and snap-fit joints are configured to secure the grating structure (11) on the rooftop (10).

Referring to FIG. 11A, in one example embodiment, the left-side member (22) and the right-side member (25) may further include protuberances (44) configured to receive locking elements (34). In one implementation, the locking elements (34) may include lockdown clamps (45), whereby the lockdown clamps (45) are affixed to the vehicle (101).

In some implementations, the safety system (100) includes a plurality of grating structures (11), each of the plurality of grating structures (11) is arranged and configured to form a combined grating structure (46) such that the combined grating structure (46) is configured to be mounted on a rooftop (10). The plurality of grating structures (11) is connectible together. The locking elements (34) are configured to be secured to the combined grating structure (46) on the rooftop (10), wherein each of the plurality of grating structures (11) is configured to form a substantially enclosed space (35) between each of the plurality of grating structures (11) and the rooftop (10) so as to hold in-place ice (36) formed on the rooftop (10) and prevent the ice (36) from falling out from the rooftop (10).

Each grating structure (11) includes a joint element (47) such that each grating structure (11) is connectible with one another. In one implementation, the joint element (47) is configured such that the plurality of grating structures (11) is releasably connectible together. Alternatively, the joint element (47) may be configured such that the plurality of grating structures (11) is fixedly connectible together.

Referring to FIG. 11A, in one example embodiment, the joint elements (47) can be joint clips (48). In another example embodiment, the joint elements (47) may be snap-fit joints (60). In another example embodiment, the joint elements (47) may be welding joints. In another example embodiment, the joint elements (47) may be a fastener, e.g., screw and nut.

In some implementations, there are multiple grating structures (11) to cover the rooftop of the trailer, i.c., 53 feet long by 8 feet wide rooftop trailer. It should be appreciated that there are adequate grating structures (11) to substantially cover the rooftop of the trailer. One skilled in the art would appreciate the dimensions of the grating structure (11) will vary dependent upon the size of the rooftop and/or the particular vehicle to be installed upon. In some implementations, the grating structure (11) is connected to each other in a side-by-side configuration. As shown in FIG. 11A, at least one side end of each grating structure (11) is connected to another side end of the grating structure (11) via a connecting element (48), which has been discussed herein carlier.

In some implementations, the grating structure (11) may include more than one top member (12) which may overlay on top of each other, resulting in a higher strength structure. In some implementations, there may also be more than one left-side member (22), more than one right-side member (25), more than one front member (28), and/or more than one rear member (31) attached to each other to provide a stronger structure.

In some implementations, the system (100) may include a heating element to remove or dissipate snow and/or ice from the rooftop (10). For example, the heating element can be heating wires (or cables) or a heating mat that lays or rests on top of the rooftop (10). In other implementations, the heating clement can utilize the vehicle's coolant system to melt the snow and/or ice from the vehicle. In other implementations, the heating element can be an electromagnetic deicer installed on the top of the rooftop of the vehicle.

In some implementations, the system (100) may include a protective member to protect the grating structure (11) against the rooftop of the trailer. For example, the protective member can be made from a plastic material and/or a rubber material. The protective member can be attached to the left-side member (22) at and along the protective end (24) of the left-side member (22) and/or attached to the right-side member (25) at and along the protective end (27) of the right-side member (25). In another example embodiment, the protective member can be configured to be attached to the rear member (31) at and along the protective end (33) of the rear member (31). In another example embodiment, the protective member (41) is configured to be attached to the front member (28) at and along the protective end (30) of the front member (28).

In one example embodiment, the vehicle (101) for the safety system (100) may be a tractor-trailer, and the rooftop (10) for the safety system (100) may be a trailer rooftop.

The articles “a” and “an,” as used herein, mean one or more when applied to any feature in embodiments of the present disclosure described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

“At least one,” as used herein, means one or more and thus includes individual components as well as mixtures/combinations.

The transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinarily associated with the specified material(s). The term “consisting essentially of” limits the scope of a claim to the specified elements, steps or material(s) and those that do not materially affect the basic and novel characteristic(s) of the claimed disclosure. All materials and methods described herein that embody the present disclosure can, in alternate embodiments, be more specifically defined by any of the transitional terms “comprising,” “consisting essentially of,” and “consisting of.”

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the invention has been described with reference to a preferred embodiment, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A safety system for preventing ice from falling out from a rooftop of a vehicle, the system comprising:
a grating structure configured to be mounted on a rooftop, including:
a top member having a generally planar shape, the top member sized to cover about the rooftop, the top member being generally parallel to the rooftop, the top member having a front, left, right, and rear end, wherein the top member has a plurality of openings configured to receive snow and water therethrough;
a left-side member extending from the left end of the top member downwardly to the rooftop, the left-side member having a top end and a bottom end, the left-side member configured to attach to the top member at and along the top end and to attach to the rooftop at and along the bottom end;
a right-side member extending from the right end of the top member downwardly to the rooftop, the right-side member having a top end and a bottom end, the right-side member configured to attach to the top member at and along the top end and to attach to the rooftop at and along the bottom end;
a front member extending from the front end of the top member downwardly to the rooftop, the front member having a top end and a bottom end, the front member configured to attach to the top member at and along the top end and to attach to the rooftop at and along the bottom end; and
a rear member extending from the rear end of the top member downwardly to the rooftop, the rear member having a top end and a bottom end, the rear member configured to attach to the top member at and along the top end and to attach to the rooftop at and along the bottom end; and
locking elements configured to secure the grating structure on the rooftop;
wherein the top member, left-side member, right-side member, front member, and rear member of the grating structure are configured to form a substantially enclosed space between the grating structure and the rooftop so as to hold in-place ice formed on the rooftop and prevent the ice from falling out from the rooftop.

2. The safety system of claim 1, wherein each of the left-side member and right-side member comprises a plurality of openings.

3. The safety system of claim 1, wherein the front member of the grating structure comprises a plurality of openings, the front member being oriented toward the front side of the vehicle.

4. The safety system of claim 1, wherein the grating structure further comprises at least one center member extending from the bottom surface of the top member downwardly to the rooftop.

5. The safety system of claim 1, wherein the top member of the grating structure comprises a plurality of drainage members attached to the bottom surface of the top member configured to drain away water flowed through the plurality of openings.

6. The safety system of claim 1, wherein the grating structure further comprises two bottom members, one bottom member configured to attach to the left-side member at and along the bottom end of the left-side member, the other bottom member configured to attach to the right-side member at and along the bottom end of the right-side member, each of the two bottom members extending toward one another.

7. The safety system of claim 1, wherein the locking elements comprise straps and ratchets, the straps and ratchets configured to secure the grating structure on the rooftop, the ratchets affixed to the vehicle.

8. The safety system of claim 1, wherein each of the left-side member and right-side member of the grating structure comprises protuberances configured to receive locking elements, and the locking elements comprise lockdown clamps, the lockdown clamps affixed to the vehicle.

9. The safety system of claim 1, further comprising a heating element.

10. A safety system for a rooftop for preventing ice from falling out from a rooftop of a vehicle, the system comprising:
a plurality of grating structures, each of the plurality of grating structures arranged and configured to form a combined grating structure such that the combined grating structure is sized to cover about a rooftop, the combined grating structure configured to be mounted on a rooftop, the plurality of grating structures being connectible together, each of the plurality of grating structures including:
a top member having a generally planar shape, the top member being generally parallel to the rooftop, the top member having a front, left, right, and rear end, wherein the top member has a plurality of openings configured to receive snow and water therethrough;
a left-side member extending from the left end of the top member downwardly to the rooftop, the left-side member having a top end and a bottom end, the left-side member configured to attach to the top member at and along the top end and to attach to the rooftop at and along the bottom end;
a right-side member extending from the right end of the top member downwardly to the rooftop, the right-side member having a top end and a bottom end, the right-side member configured to attach to the top member at and along the top end and to attach to the rooftop at and along the bottom end;
a front member extending from the front end of the top member downwardly to the rooftop, the front member having a top end and a bottom end, the front member configured to attach to the top member at and along the top end and to attach to the rooftop at and along the bottom end;
a rear member extending from the rear end of the top member downwardly to the rooftop, the rear member having a top end and a bottom end, the rear member configured to attach to the top member at and along the top end and to attach to the rooftop at and along the bottom end; and
joint elements configured such that the plurality of grating structures is releasably connectible together; and
locking elements configured to secure the combined grating structure on the rooftop;
wherein the top member, left-side member, right-side member, front member, and rear member of each of the plurality of grating structures are configured to form a substantially enclosed space between each of the plurality of grating structures and the rooftop so as to hold in-place ice formed on the rooftop and prevent the ice from falling out from the rooftop.

11. The safety system of claim 10, wherein each of the left-side member and right-side member of each of the plurality of grating structures has a plurality of openings.

12. The safety system of claim 10, wherein the front member of each of the plurality of grating structures has a plurality of openings, the front member being oriented toward the front side of the vehicle.

13. The safety system of claim 10, wherein the top member of each of the plurality of grating structures comprises a plurality of drainage members attached to the bottom surface of the top member configured to drain away water flowed through the plurality of openings.

14. The safety system of claim 10, wherein each of the plurality of grating structures further comprises two bottom members, one bottom member configured to attach to the left-side member at and along the bottom end of the left-side member, the other bottom member configured to attach to the right-side member at and along the bottom end of the right-side member, each of two bottom members extending toward one another.

15. The safety system of claim 10, wherein the locking elements comprise straps and ratchets, the straps and ratchets configured to secure the combined grating structure on the rooftop, the ratchets affixed to the vehicle.

16. The safety system of claim 10, wherein at least one left-side member and right-side member of the plurality of grating structures comprise protuberances configured to receive locking elements, and the locking elements comprise lockdown clamps, the lockdown clamps affixed to the vehicle.

17. The safety system of claim 10, wherein each of the left-side member and right-side member of the plurality of grating structures has a height dimension in a range from about one inch to about three inches.

18. The safety system of claim 10, further comprising a heating element.

19. A safety system for a rooftop for preventing ice from falling out from a rooftop of a vehicle, the system comprising:
a grating structure configured to be mounted on a rooftop, including:
a plurality of top members, each of the plurality of top members arranged and configured to form a combined top member, the combined top member sized to cover about the rooftop, each of the plurality of top members having a generally planar shape, each of the plurality of top members being generally parallel to the rooftop, the combined top member having a front, left, right, and rear end, each of the plurality of top members being connectible together, wherein each of the plurality of top members has a plurality of openings configured to receive snow and water therethrough;
at least one left-side member extending from the left end of the combined top member downwardly to the rooftop, the at least one left-side member having a top end and a bottom end, the at least one left-side member configured to attach to the combined top member at and along the top end and to attach to the rooftop at and along the bottom end;
at least one right-side member extending from the right end of the top combined top member downwardly to the rooftop, the at least one right-side member having a top end and a bottom end, the at least one right-side member configured to attach to the combined top member at and along the top end and to attach to the rooftop at and along the bottom end;
at least one front member extending from the front end of the combined top member downwardly to the rooftop, the at least one front member having a top end and a bottom end, the at least one front member configured to attach to the combined top member at and along the top end and to attach to the rooftop at and along the bottom end;
at least one rear member extending from the rear end of the combined top member downwardly to the rooftop, the at least one rear member having a top end and a bottom end, the rear member configured to attach to the combined top member at and along the top end and to attach to the rooftop at and along the bottom end; and
locking elements configured to secure the grating structure on the rooftop;
wherein the combined top member, left-side member, right-side member, front member, and rear member of the grating structure are configured to form a substantially enclosed space between the grating structure and the rooftop so as to hold in-place ice formed on the rooftop and prevent the ice from falling out from the rooftop.

20. The safety system of claim 19, wherein each of the plurality of top members is configured to have a tongue and groove joint such that each of the plurality of top members is connectible together.
